(19) United States
(12) Patent Application Publication
(10) Pub. No.: US 2014/0159519 A1
(43) Pub. Date: Jun. 12, 2014

(54) BUSBAR THAT CAN BE INTEGRATED INTO AN ELECTRIC MOTOR

(71) Applicant: MERSEN FRANCE SB SAS, Saint-Bonnet-de-Mure (FR)

(72) Inventors: Herve FORVEILLE, Gene (FR); Francois ANNE, Angers (FR)

(73) Assignee: MERSEN FRANCE SB SAS, Saint-Bonnet-de-Mure (FR)

(21) Appl. No.: 13/845,141

(22) Filed: Mar. 18, 2013

(30) Foreign Application Priority Data
Dec. 11, 2012 (FR) 12 61893

(51) Int. Cl. H02K 3/28; H02K 15/00

(52) U.S. Cl. CPC H02K 3/28; H02K 15/0062
USPC 310/71; 29/874

(57) ABSTRACT

This busbar (1) includes at least two conductive elements (10, 16, 20, 26, 30, 36, 40) which include electrical connection elements (14, 24, 34, 18, 28, 38, 44) of windings belonging to the stator of an electric machine. All of the conductive elements (10, 16, 20, 26, 30, 36, 40) are each cut out from a plate of electrically conduction material, bent according to a direction perpendicular to the thickness of the plate and radially superimposed in relation to a central axis (Y-Y) that is common to the conductive elements (10, 16, 20, 26, 30, 36, 40).

The invention relates to a busbar intended to be integrated into an electric machine. Electric machine means a motor or a generator, and even a motor-generator that can function both as a motor and generator.

A busbar is a set of conductive elements provided with electrical connection means. In the field of power electronics, a busbar is often used for high current values where traditional electrical connection means, such as cables or printed circuits, are no longer suited. This because the conductive elements of a busbar most often have a particular geometry such as a tube or a bar and are not very thick in order to accentuate the skin effect and as such dissipate the least amount of energy possible. The invention is interesting in the event it is desired to connect together the windings of the stator of an electric machine. For the purposes of simplification, the case wherein the electric machine is a motor shall be covered here, although the invention also applies to generators or to motor-generators.

It is known that the stator of an electric machine can receive several groups of windings or coils according to the number of phases of the motor. In an electric motor, the connection of the windings to the electricity network is carried out by means of a terminal block, which is a device that makes it possible to provide for the electrical continuity of the output cables of the windings to the mains. This terminal block is included in the motor and protected by a casing fixed on the motor. Each winding comprises one or several flat or winding wires, more preferably made of copper and all of the wires are wound in the same way, with each wire having two ends, with all the ends on either side of the wires constituting the two outputs of a winding. To do this, according to a known technique, the windings of a group of windings are connected together by the intermediary of cables, with each of them having a section determined according to the power of the motor. According to the type of terminal block, the outputs of the windings are then doubled or even tripled. This creates a problem of space, assembly time and cost of raw materials, as well as reliability since the risk of a cabling error is high.

A motor using cables is moreover relatively heavy, of great size and has a high inductance. Indeed, using cables imposes that the manufacturer should solder the end of the cables to the terminal block. As solder constituting resistances oppose the electric current, it is then suitable to use windings that have a higher inductance, in order to take into account the losses in electrical energy linked to the solder. However, using a high inductance implies that at high frequencies, the windings oppose a strong resistance to the passage of the current. The electric current passing through the windings is therefore low, in the same way as the motor torque which is directly proportional to it.

It is these disadvantages that the invention intends more particularly to overcome by proposing a busbar that is easily integrated into an electric machine in order to connected together the windings of the stator of this machine.

To this effect the invention relates to a busbar comprising at least two conductive elements which comprise electrical connection means of windings belonging to the stator of an electric machine, characterised in that all of the conductive elements are each cut out from a plate of electrically conductive material, bent according to a direction perpendicular to the thickness of the plate and radially superimposed in relation to a central axis that is common to the conductive elements.

Thanks to the invention, it is possible to connect the windings of the same group of windings together in a manner that takes up less space, that is more economical, simpler to assemble and more reliable. The invention also makes it possible to simplify the connection of a group of windings to the terminal block of an electric machine.

According to advantageous but not mandatory aspects of the invention, a busbar can incorporate one or several of the following characteristics, taken in any technically permissible combination:
All of the conductive elements of the busbar have a circular profile.
All of the conductive elements of the busbar have a polygonal profile.
At least one of the conductive elements of the busbar extends over an angle strictly less than 360° around the common central axis.
The electrical connection means are output lugs all directed in the same direction, along the common axis and in relation to the conductive elements.
The busbar comprises at least one layer of electrical insulation which is radially arranged between two conductive elements of each pair of conductive elements radially superimposed in relation to the central axis or inside the conductive element the most internal to the busbar or around the conductive element the most external to the busbar.

The invention further relates to an electric machine comprising a stator which comprises a cylindrical and hollow core, and at least two groups of at least one winding, respectively associated to a phase of the electric machine and a rotor which rotates coaxially inside the stator. This machine is characterised in that it further comprises a busbar such as mentioned hereinabove and of which the common central axis is confounded with the axis of the stator.

As such, it is possible to easily integrate the busbar into the electric machine, without however substantially making it heavy, or even increasing the dimensions of the machine.

According to advantageous but not mandatory aspects of the invention, such an electric machine can incorporate one or several of the following characteristics, taken in any technically permissible combination:
Each group of windings comprises several windings and several conductive elements of the busbar are connected to the windings of the same group.
All of the groups of windings of the stator are connected to a neutral conductor of the busbar.
The output lugs of the conductive elements are angularly arranged around the axis of the stator in such a way that, in an assembled configuration of the busbar on the stator, each output lug is located axially opposite at least one output of a winding.

The invention finally relates to a method of manufacturing a busbar such as described hereinabove, characterised in that it comprises steps consisting in:
a) cutting out of from an electrically conductive plate a strip of material for each conductive element
b) affixing a layer of electrical insulation on each strip
c) winding each strip according to a direction perpendicular to its thickness in such a way as to centre the strip on an axis.

According to advantageous but not mandatory aspects of the invention, such a method can incorporate one or several of the following characteristics, taken in any technically permissible combination:
This method further comprises a step d) posterior to the step c), consisting in aligning all of the axes whereon the strips are centred in order to form a common central axis, then in nesting the conductive elements via radial superposition of the conductive elements around the common axis.
This method further comprises a step e), posterior to the step b) and prior to the step c), consisting in stacking the conductive elements on top of each other, according to a direction perpendicular to their thickness.

The invention shall be better understood and other advantages of the latter shall appear more clearly when reading the following description of two embodiments of a busbar and of an electric motor in accordance with its principle, provided by way of example and made in reference to the annexed drawings wherein:

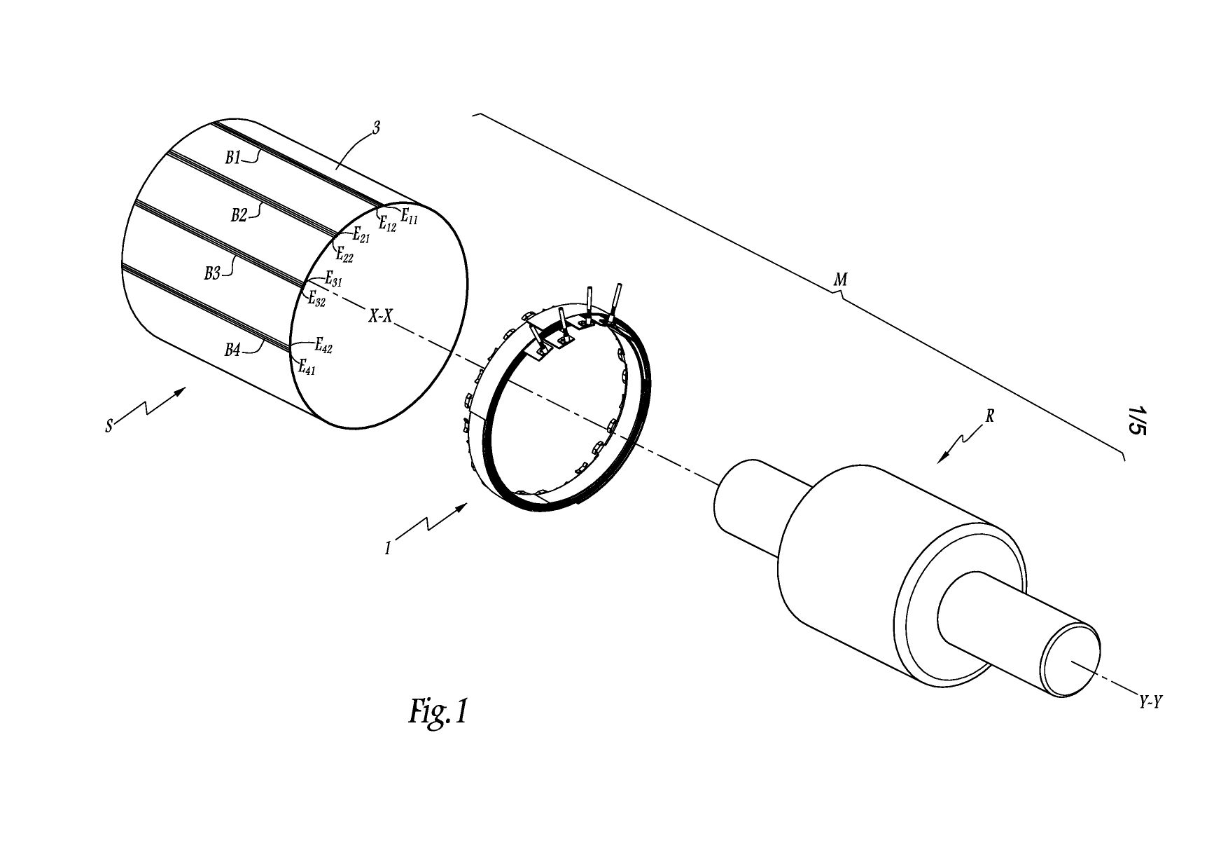

FIG. 1 is an exploded perspective block diagram of an electric motor in accordance with the invention incorporating a busbar in accordance with the invention,

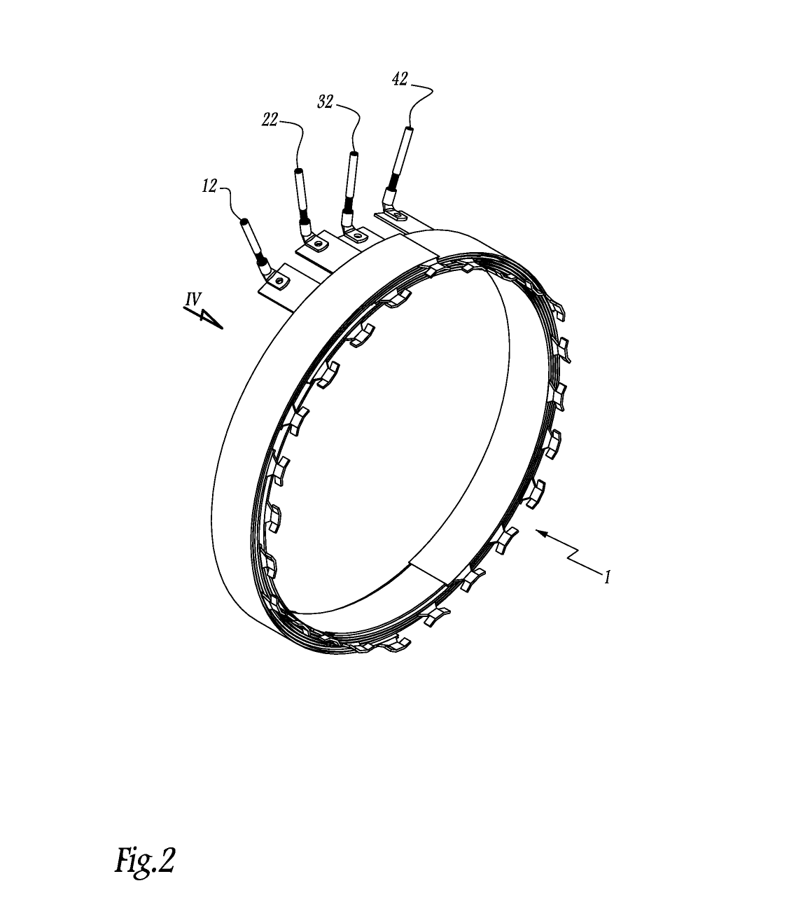

FIG. 2 is a perspective view on a larger scale of the busbar of the motor of FIG. 1, under a viewing angle different from that of FIG. 1,

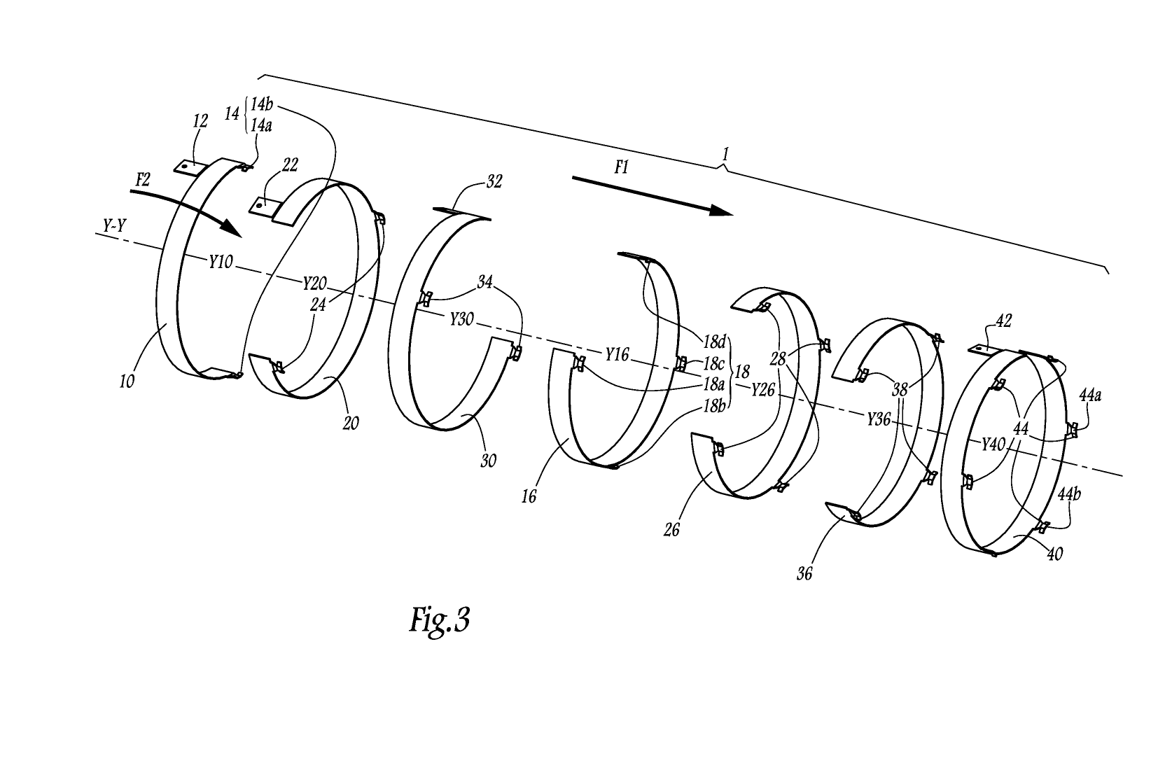

FIG. 3 is an exploded perspective view of the busbar of FIG. 1,

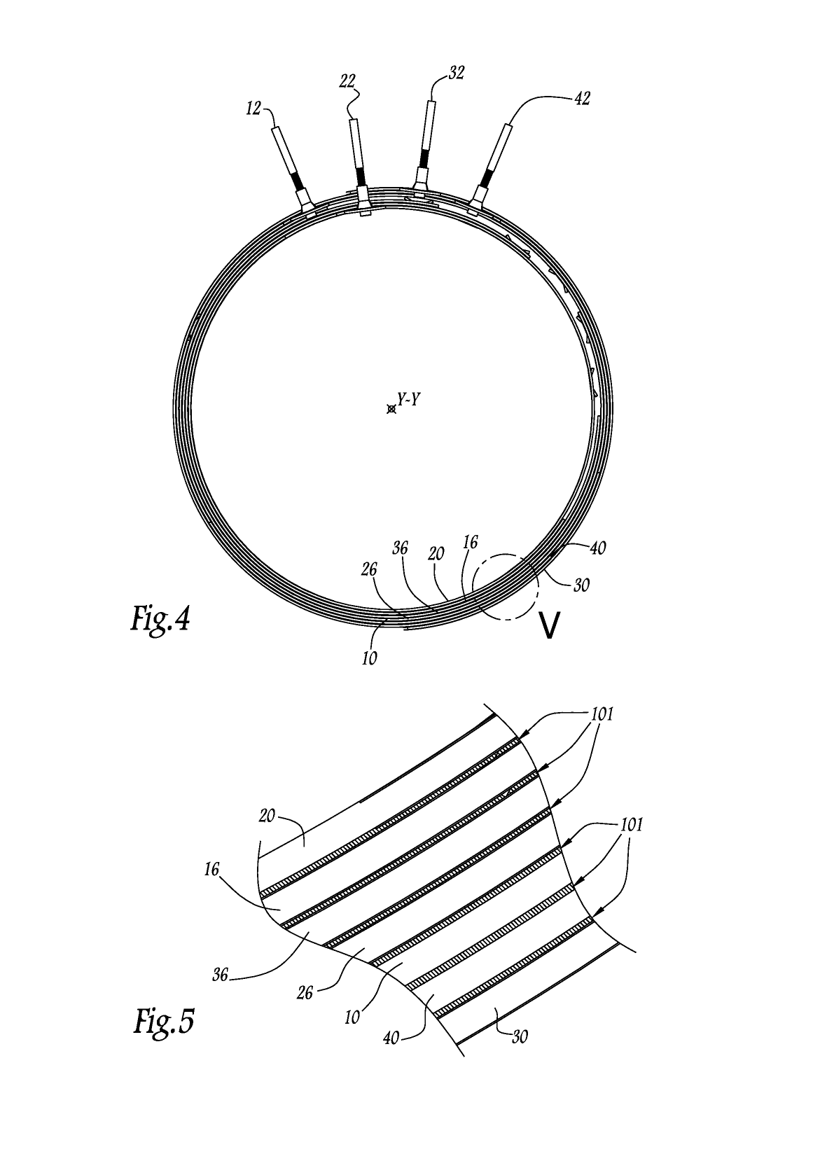

FIG. 4 is an overhead view according to the arrow IV of FIG. 2,

FIG. 5 is a view on a larger scale of the encircled zone V in FIG. 4 and,

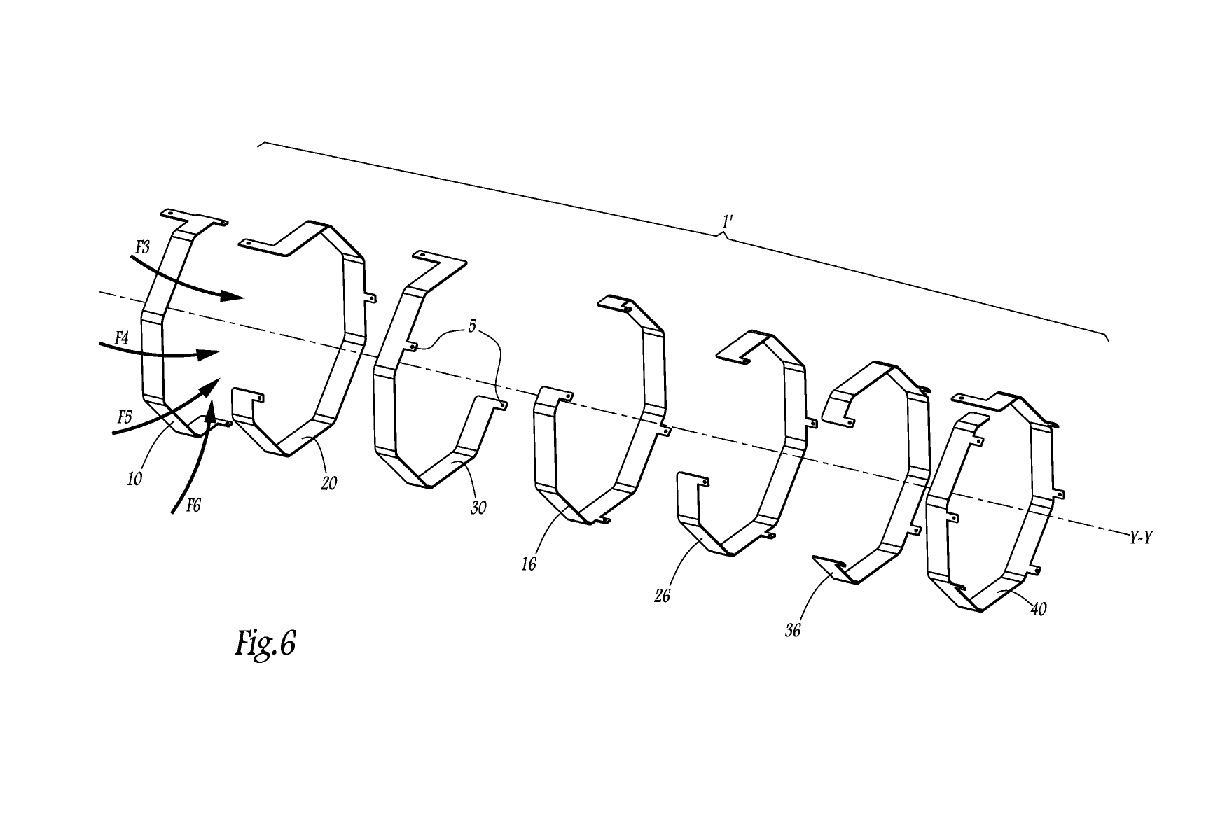

FIG. 6 is a view similar to FIG. 3, for a busbar in accordance with a second embodiment of the invention.

FIG. 1 shows a motor M comprising on the one hand, a stator S which includes, on the one hand, a cylindrical and hollow core 3, centred on a geometrical axis X-X, and, on the other hand, a rotor R, which is mounted inside the stator S rotating about itself around the axis X-X.

The stator S is provided with windings. More precisely, the aforementioned cylindrical and hollow core 3 comprises twenty-four notches receiving twelve windings or coils which are distributed around the axis X-X of the core 3, i.e. extending over a portion of the core 3. Generally, the number of windings as well as the number of notches used depends on the power of the motor. Recall that a winding is a rolling of one or several winding wires, often made of copper, around a geometry defined by the two aforementioned notches. In the example, a group of windings comprises four windings B₁, B₂, B₃ and B₄. However, the number of windings used in a group of windings also depends on the power of the motor.

In FIG. 1, only one group of windings is shown, for reasons of clarity of the drawing, and the windings B₁ to B₄ are figured by a few windings, although in reality they comprise many windings.

The windings B₁, B₂, B₃ and B₄ each include two outputs, defined by the two ends of the winding wire or wires that they are comprised of and respectively denoted as E₁₁ and E₁₂, E₂₁ and E₂₂, E₃₁ and E₃₂ and E₄₁ and E₄₂. Moreover, the motor M which is triple-phased, is provided with three groups of windings each corresponding to a phase of the motor. The windings of a group of windings are connected together, in series or in parallel according to the electrical diagram selected, and an alternating current flows through them. As mentioned previously, the connection of the windings B₁ to B₄ and equivalents of the stator S to the mains is carried out by means of a terminal block not shown and belonging to the motor M.

For the three-phased motor M, the terminal block comprises three phase terminals, each corresponding to a phase of the mains and a neutral terminal, normally connected to the ground. As such, the stator S carries two groups of windings, similar to that formed by the windings B₁ to B₄, with these two groups of windings not being shown.

Each group of windings has an output intended to be connected to the corresponding electrical phase as well as to at least one output intended to be connected to the neutral of the terminal block.

In addition, as shown in FIG. 1, the motor M comprises a busbar 1 which electrically connects the windings of the stator S together and to the terminal block. This busbar 1 is shown alone in the FIGS. 2 to 5 and details shall be provided hereinafter. In the motor M in the assembled state, the busbar 1 is inserted inside an axial end of the core 3, i.e. that visible in FIG. 1.

The busbar 1 comprises several conductive elements assembled geometrically and/or electrically with one another. In the present case, the conductive elements are portions of rings all with different diameters, which are centred around a common central axis Y-Y, which, in assembled configuration of the busbar 1 on the stator 3, is confounded with the longitudinal axis X-X of the stator S. The rings of the busbar 1 are of a number of seven and each have a circular profile, extending over an angle less than 360° around the common axis Y-Y. Using rings with a circular section astutely makes it possible to reduce the material cost.

Moreover, a layer of electrical insulation, 101 shown solely in FIG. 5, is arranged between each pair of two adjacent rings and/or on the inner surface and/or on the outer surface of the busbar 1 in order to prevent any short-circuit or poor circulation of the current.

The rings 10, 20, and 30 which are on the left portion of FIG. 3, are rings intended to be connected to the terminal block of the motor M, not shown in the figures. As such, each of these rings 10, 20 and 30 comprises an input terminal, respectively denoted 12, 22 and 32 corresponding to a phase of the motor. It is therefore understood that using such a busbar 1 has for advantage to suppress the cables used in double or in triplicate, which beforehand made it possible to provide for the connection to the terminal block.

These rings 10, 20 and 30 each further include one or several output lugs, respectively denoted 14, 24 and 34 intended to be connected to the windings of the stator.

In the present case, it is therefore understood that having two output lugs on the rings 10, 20 and 30 corresponds to a parallel connection, inversely, the presence of a single output lug would imply a connection in series.

The three following rings in order starting from the left, 16, 26 and 36 are rings for putting in series or for putting in parallel, according to the electrical diagram of the motor M. These rings specific to the type of electrical diagram are called interconnection rings. Each of these interconnection rings 16, 26 and 36 further include input/output lugs, respectively denoted 18, 28 and 38 which are used as a point of electrical connection of the ends of the windings of the stator 3. In this example, they are of a number of four on each interconnection ring 16, 26 and 36, but this depends on the number of windings in a group of windings and therefore on the power of the motor. The interconnection rings 16, 26 and 36 therefore do not comprise an input terminal that can be connected to the terminal block and are designed in such a way that, in the assembled configuration of the busbar 1 on the stator 3, they are respectively connected electrically to the rings 10, 20 and 30 through a winding. Indeed, the two output lugs 14, 24 and 34 are each connected, independently and respectively through a winding, to an output lug 18, 28 and 38 belonging to the corresponding interconnection ring 16, 26 and 36.

The first ring starting from the right in FIG. 3 is a ring 40 intended to be connected to the neutral of the terminal block. Indeed, it is necessary in order to close the electrical circuit of each phase that each group of windings, is connected to the neutral of the terminal block. That is why the busbar 1 comprises, in the case of a three-phase motor, the ring 40, providing the connection of each group of windings to the neutral of the terminal block. For this, the ring 40 comprises an input terminal 42, making it possible to connect the ring 40 to the neutral of the terminal block.

For a parallel connection, two windings are required to connect each branch in parallel to the neutral terminal For three phases, six windings are then connected to the neutral terminal. That is why the ring 40 connected to the neutral terminal of the power supply comprises six output lugs, denoted 44.

The output lugs 14, 24, 34, 44, 18, 28 and 38 are crimped around winding wires of the windings of the stator S by means of a clamp which also makes it possible to melt the varnish in order to provide the electrical contact. As an alternative, it is also possible, in order to provide the electrical contact, to solder the end of the winding wires onto the output lugs 14, 24, 34, 18, 28, 38 and 44 or to immobilise the winding wires in ring terminals which are then screwed onto the output lugs 14, 24, 34, 18, 28, 38 and 44 each one provided with a suitable tapping.

The rings 10, 20, 30, 16, 26, 36 and 40 are all obtained using plates of a conductive material. With a concern for clarity, only the method of manufacturing the ring 10 is described hereinbelow, this method is applied by transposition to the other rings 20, 30, 40, 16, 26 and 36. In a first step, a plate of conductive material, for example a plate of sheet metal, is cut out in the shape of a strip, by preserving the input terminal 12 and the output lugs 14. Then, a layer of electrical insulation 101 is affixed on this strip. The fixing of the layer of electrical insulation 101 on the strip can take place via any suitable technique, in particular via rolling. So, a rolled strip is a strip on which a layer of electrical insulation is affixed.

Finally, this strip provided with a layer of insulation is bent according to a direction F2, perpendicular to the thickness of the plate, and around a central axis Y10 which, in configuration of the busbar 1, is confounded with the central axis Y-Y of the busbar.

The same type of operations are repeated for cutting, providing with a layer of insulation and bending or “rolling” the strips 20, 30, 16, 26, 36 and 40.

In order to provide more precise details on the connection of the windings of the stator S, we shall focus, for the purposes of simplification, on the electrical connection of the group of windings B₁, B₂, B₃ and B₄, and we shall consider that the rings 10 and 16 are associated with this group. In addition, note for the clarity of the description, 14a and 14b the two output lugs 14 of the ring 10 and 18a, 18b, 18c and 18d the four output lugs 18 of the ring 16. Note also 44a and 44b two output lugs among the output lugs 44.

As such, it is understood that the end E₁₁ of the winding B₁ is crimped in the output lug 14a of the ring 10 and the end E₁₂ is crimped in the output lug 18a. In parallel, the end E₂₁ of the winding B₂ is crimped in the output lug 14b of the ring 10 and the end E₂₂ is crimped in the output lug 18b. In order to complete the circuit, the two remaining windings B₃ and B₄ have their ends E₃₁ and E₃₂ and E₄₁ and E₄₂ respectively crimped in the output lugs 18c and 44a and 18d and 44b. Moreover, the connection of this group of windings is not limited to the example mentioned hereinabove as all of the combinations are possible.

As such, the output lug 14a or 14b can very well be connected to one of the output lugs 18a, 18b or 18d and, similarly, two of the output lugs 18a, 18b, 18c and 18d can be connected to two of the output lugs 44a and 44b indifferently.

On the other hand, there is still a preferred combination which is to connect the end of the windings directly with the output lug axially opposite. This makes it possible to limit the space used by the connection between the windings and the output lugs. To this effect, the busbar 1 is designed in such a way that, in the assembled configuration of the busbar 1, as shown in FIG. 2, each output lug 14, 24, 34, 18, 28, 38 and 44 respectively rings 10, 20, 30, 16, 26, 36 and 40, is angularly arranged around the axis X-X, so that it is located axially at the opposite of an end of a winding.

The alignment of the rings 10, 20, 30, 16, 26, 36 and 40 in relation to one another brings the busbar into the configuration of FIG. 3. In this configuration, the axes Y10, Y20, Y30, Y16, Y26, Y36 and Y40 whereon the rings 10, 20, 30, 16, 26, 36 and 40 have been respectively centred are all confounded with the axis Y-Y. It is then suitable to elastically deform the rings so as to be able to radially superimpose them and bring the busbar into the configuration of FIG. 2. This elastic deformation is favoured by the fact that the rings 10, 20, 30, 16, 26, 36 and 40 extend over less than 360°, respectively around the axes Y10, Y20, Y30, Y16, Y26, Y36 and Y40. More precisely, a ring 10 extends on an angle of about 180° respectively around the axis Y10, while the rings 20, 30, 16, 26 and 36 extend over an angle of about 270° respectively around the axes Y20, Y30, Y16, Y26 and Y36, and the ring 40 extends over an angle of about 350° around the axis Y40. However, in terms of an alternative not shown, it is possible that one or several rings of the busbar 1 are closed and extend therefore over 360°. Here, it can be considered that the ring 40 is closed instead of extending over about 350°. In addition, deforming the rings 10, 20, 30, 16, 26, 36 and 40 elastically implies that the elastic return, exerting according to a radial direction around the central axis Y-Y, of this deformation tends to improve the mechanical strength of the busbar 1 in its assembled configuration as the latter is under stress.

In opposition with a complete assembly of the individual rings 10, 20, 30, 16, 26, 36, 40, it is also possible to assemble the busbar 1 using several rolled multi-conductor rings each comprising several conductive layers, forming conductors, and several layers of insulation. These multi-conductor rings are bent. More precisely, it can be imagined to roll, that is affixing a layer of electrical insulation, then bend a few single-conductor rings together, such as for example the rings 10, 20 and 30, as such forming a multi-conductor ring, carrying out the same operation for the rings 16, 26, 36 and 40 then to assemble the two multi-conductor rings formed as such. Naturally, this method of assembly is not limited to the assembly of two multi-conductor rings, the number of multi-conductor rings to be assembled being determined in order to simplify the method of manufacture.

A third possibility is to roll all of the strips using layers of insulation, then to superimpose the strips and finally to bend all of the strips and layers together, in order to give the busbar 1 a shape centred on the common central axis Y-Y.

In addition, in terms of an alternative not shown, it is possible to add a layer of electrical insulation on the inner surface of the ring 20 the most internal to the busbar 1 and a layer of electrical insulation on the external surface of the ring 30 the most external to the busbar 1.

Moreover, it is necessary, during the assembly to position all of the output lugs 14, 24, 34, 18, 28, 38 and 44 in the same direction F1, which is a longitudinal direction oriented from the left to the right along the axis Y-Y in FIG. 3, and this in order to prevent an assembly error.

In addition, it is suitable to arrange each output 12, 22, 32 and 42 intended to be connected to the terminal block side by side. The connection of the busbar 1 to the terminal block will as such be facilitated.

Note that the order of radial superposition of the rings 10, 20, 30, 16, 26, 36 and 40 of the busbar 1, better shown in FIG. 5, is important, since each ring 10, 20, 30, 16, 26, 36, 40 has a different diameter, and that this constitutes a mechanical fool-proof device making it possible to comply with the stacking order of the rings 10, 20, 30, 40, 16, 26 and 36. In addition, each ring is arranged, angularly in a precise manner, so that each output lug 14, 18, 24, 28, 34, 38, 44 of the rings 10, 20, 30, 16, 26, 36 and 40 is axially opposite the output of the corresponding winding. It is therefore understood that there is only one way to assemble the busbar 1.

Other embodiments can be considered concerning this invention. By way of example, it is possible to use solely one ring 10, 20, 30 per phase, without using interconnection rings 16, 26, 36.

Another embodiment resides in the use of a busbar 1′, of a shape that is not circular, but polygonal, shown as an exploded view in FIG. 6, wherein each ring of the busbar 1′ is folded in the shape of a polygon which may be uninterrupted. Indeed, if one takes the example of the conductive element 10, the latter is cut out of a plate of conductive material by taking care to preserve the electrical connection means, then is rolled with a layer of electrical insulation and finally wound around a central axis, by means of several folding operations.

It is therefore understood that the bending of a conductive element 10 or equivalent can be interpreted, either as a deformation aiming to give the conductive element 10 a circular or rounded shape, or as several folding operations aiming to give the conductive element 10 a polygonal shape.

In the case of FIG. 6, four folding operations are carried out, perpendicularly to the thickness of the conductive element 10 and according to four different directions F₃, F₄, F₅ and F₆. The invention can be carried out regardless of the number of foldings, as long as the number and the folding zones are the same for all of the conductive elements 10, 20, 30, 16, 26, 36 and 40.

When all of the conductive elements are each respectively wound or bent, around their central axis, it is suitable to align them around a common central axis Y-Y then to reassemble them via radial superposition in relation to this common central axis Y-Y, as in the first embodiment.

Moreover, in this embodiment, the connection of the output lugs 14, 24, 34, 18, 28, 38 and 44 is carried out by means of nuts and bolts as shown by the threaded holes 5, shown by way of example solely on the ring 30 of FIG. 6 but which are arranged on each of the rings 10, 20, 30, 40, 16, 26 and 36. These threaded holes 5 pass through the output lugs 14, 24, 34, 18, 28, 38 and 44 and are intended to receive the tightening screws.

In the preceding description, the electric motor M is three-phased as this embodiment lends itself well to the use of the busbar 1. However, this does not means that the invention is limited to this embodiment: the invention also has application in motors of the single-phase type, and even comprising a number of phases strictly greater than three.

1. Busbar comprising at least two conductive elements which comprise electrical connection means of windings belonging to the stator of an electric machine, wherein all of the conductive are each cut out of a plate of electrically conductive material, bent according to a direction perpendicular to the thickness of the plate and radially superimposed in relation to a central axis common to the conductive elements.

2. Busbar according to claim 1, wherein all of the conductive elements of the busbar have a circular profile.

3. Busbar according to claim 1, wherein all of the conductive elements of the busbar have a polygonal profile.

4. Busbar as claimed in claim 1, wherein at least one of the conductive elements of the busbar extends on an angle strictly less than 360° around the common central axis.

5. Busbar as claimed in claim 1, wherein the electrical connection means are output lugs all oriented in the same direction, along the common axis and in relation to the conductive elements.

6. Busbar as claimed in claim 1, wherein the busbar comprises at least one layer of electrical insulation which is radially arranged between the two conductive elements of each pair of conductive elements radially superimposed in relation to the central axis or inside the conductive element the most internal to the busbar or around the conductive element the most external to the busbar.

7. Electric machine comprising:
a stator which comprises a cylindrical and hollow core and at least two groups of at least one winding, respectively associated with a phase of the electric machine,
a rotor which rotates coaxially inside the stator,
wherein the electric machine further comprises a busbar in accordance with claim 1, and of which the common central axis is confounded with the axis of the stator.

8. Electric machine according to claim 7 wherein each group of windings comprises several windings and in that several conductive elements of the busbar are connected to the windings of the same group.

9. Electric machine according to claim 7, wherein all of the groups of windings of the stator are connected to a neutral conductor of the busbar.

10. Electric machine according to claim 7, wherein the output lugs of the conductive elements are angularly arranged around the axis of the stator in such a way that, in the assembled configuration of the busbar on the stator, each output lug is located axially at the opposite of at least one output of a winding.

11. Method for manufacturing a busbar in accordance with claim 1, wherein it comprises steps consisting in:
a) cutting out from an electrically conductive plate a strip of material for each conductive element.
b) affixing a layer of electrical insulation on each strip
c) bending each strip according to a direction perpendicular to its thickness in such a way as to centre the strip on an axis.

12. Method according to claim 11, wherein the latter further comprises a step d) posterior to the step c), consisting in aligning all of the axes whereon the strips are centred in order to form a common central axis, then in nesting the conductive elements by radial superposition of the conductive elements around the common axis.

13. Method according to claim 11, wherein it further comprises a step e), posterior to the step b) and prior to the step c), consisting in stacking the conductive elements on one another, according to a direction perpendicular to their thickness.
